(19) United States
(12) Patent Application Publication
(10) Pub. No.: US 2009/0182851 A1
(43) Pub. Date: Jul. 16, 2009

(54) REMOTE INSTALL ASSISTANT

(75) Inventors: Nicholas V. King, San Jose, CA (US); Bob Bradley, Foster City, CA (US); Derrick M. Carty, San Jose, CA (US); Daniel Trent Preston, Campbell, CA (US); P.J. Petree, San Jose, CA (US); Imran A. Chaudhri, San Francisco, CA (US); Patrick Coffman, San Francisco, CA (US)

Correspondence Address: FISH & RICHARDSON P.C., PO BOX 1022, MINNEAPOLIS, MN, 55440-1022, US

(73) Assignee: Apple Inc.

(21) Appl. No.: 12/014,039

(22) Filed: Jan. 14, 2008

(51) Int. Cl. G06F 15/177

(52) U.S. Cl. 709/222

(57) ABSTRACT

A remote install assistant application is provided on a host device which leads the user through a series of steps for starting up a target device, and remotely installing an operating system or application from the host device onto the target device over a wireless or wired network. The assistant application, which the user can launch on the host device, can include a network installation server which makes a disc inserted in a drive of the host device available as a startup disk on the network.

### TECHNICAL FIELD

This subject matter is generally related to software installation.

### BACKGROUND

Personal computers often ship with a set of optical discs containing an operating system and bundled applications. Retail versions of operating systems are also delivered on optical discs. Occasionally, a user has to restore or update an operating system (OS) or application on a target computer or device. When using optical discs to update or restore an operating system on a computer with an optical disc drive, the computer starts up from a first optical disc in the set and installs critical components of the OS, allowing the OS full access to the computer's hard disk while installing the remaining OS components. Once the contents of the first disc is installed, the computer restarts using the newly installed OS, ejects the first disc and prompts the user to insert a second disc in the set.

Some remote install solutions allow the user to startup a computer from a network startup disk using an operating system server (e.g., Mac OS X Server). These solutions, however, do not support multiple disc installations over a wireless network connection, and setting up a server computer for this purpose is not a trivial task for an average user.

### SUMMARY

A remote install assistant application is provided on a host device which leads the user through a series of steps for starting up a target device and remotely installing an operating system or application from the host device onto the target device over a wireless or wired network. The assistant application, which the user can launch on the host device, can include a self-contained network installation server which makes a disc inserted in a drive of the host device available as a startup disk on the network.

In some implementations, there is no need for the user to change any settings on the host device. The assistant application can be used on a variety of computing platforms (e.g., Mac OS®, Windows®, Linux®) that include an integrated optical drive or that can couple (wirelessly or wired) to an external drive, such as an external optical drive or a solid state storage device (e.g., a flash drive).

In some implementations, an OS installer running on the target device allows communication with the assistant application running on the host device while the target device is installing the OS. This allows the assistant application to show detailed progress information, and also eject and request the next disc in the case of multiple disc installations.

In some implementations, the target device runs an application which provides a user interface to allow the user to join a wireless network before selecting a network startup disk. Once the user has connected to their network, the user can select the disc inserted in the host device (or inserted in a storage device coupled to the host device) as the startup disk for the target device.

Other implementations are disclosed which are directed to systems, methods, devices and computer-readable mediums.

### DESCRIPTION OF DRAWINGS

FIG. 1 is a block diagram of an example remote install system.

FIG. 2 is a flow diagram of an example remote install process.

FIGS. 3A-3G are screenshots of example instruction panes for an example remote install assistant.

FIG. 4 is a block diagram of an example host device for implementing the features and processes described in reference to FIGS. 1-3.

### DETAILED DESCRIPTION

### System Overview

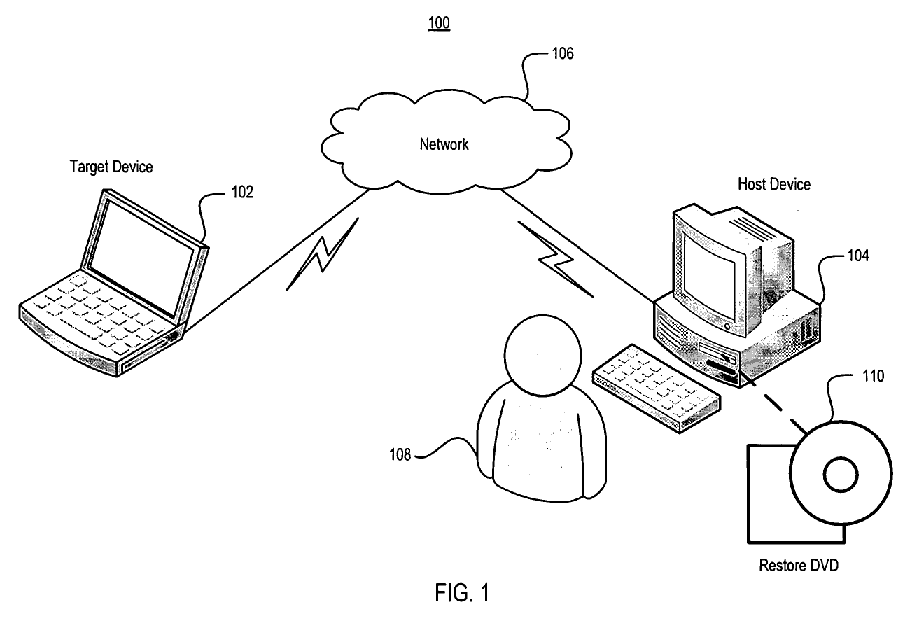

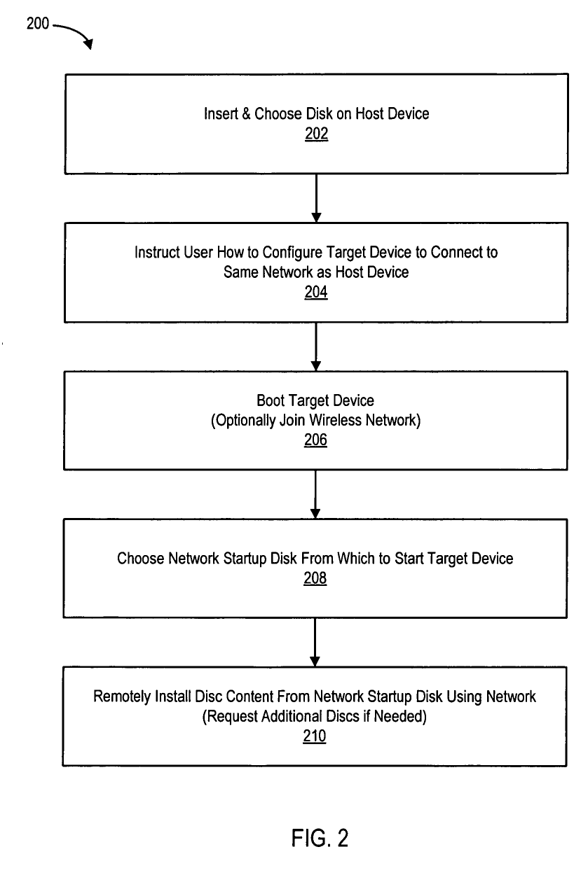

FIG. 1 is a block diagram of example remote install system 100. In some implementations, system 100 can include target device 102, host device 104 and network 106. Target device 102 and host device 104 can be any device with network connectivity, including but not limited to: a personal computer, a mobile phone, a smart phone, an email device, a game device, a media player, a tablet, an ebook reader, etc. Target device 102 can include firmware loaded in non-volatile memory (e.g., ROM, flash) which can be used to initiate OS installation, as described in reference to FIG. 2.

Host device 104 can include an integrated optical disk drive and/or an external storage device coupled to host device 104 through a wired or wireless connection. Network 106 can be a wireless local area network (e.g., Wi-Fi) or a wire network (e.g., Ethernet). Network 106 can also be a wide area network (e.g., the Internet, an intranet).

In the example shown, user 108 inserts optical disc 110 (e.g., a DVD) in an optical drive of host device 104, then initiates an assistant application on host device 104 for remotely installing an OS and/or application onto target device 102 over network 106. Target device 102 and host device 104 can communicate over wired or wireless connections with network 106.

### Example Remote Install Process

FIG. 2 is a flow diagram of example remote install process 200. In some implementations, process 200 can begin when a user inserts and chooses an optical disk (e.g., an OS restore disk 110) on a host device (202). The disc can be inserted in an integrated optical drive, an external optical drive or any other network drive that is accessible by the host device.

The user launches an assistant application on the host device. In some implementations, the assistant application presents instruction panes on a display of the host device for instructing the user how to connect a target device to the same network as the host device (204). The user boots the target device and optionally joins a wireless network (206). For target devices that use Mac OS X, the target device can run Boot Picker. Boot Picker is publicly available software that runs on startup immediately prior to LoginWindow. Based upon the target device's configuration, Boot Picker presents an option to the user to choose an operating system. Upon choosing an OS, the target device either continues to Mac OS X or reboots to the specified OS. In some implementations, the host device and target device communicate on a wired network (e.g., Ethernet), so joining a wireless network can be an optional step for the user.

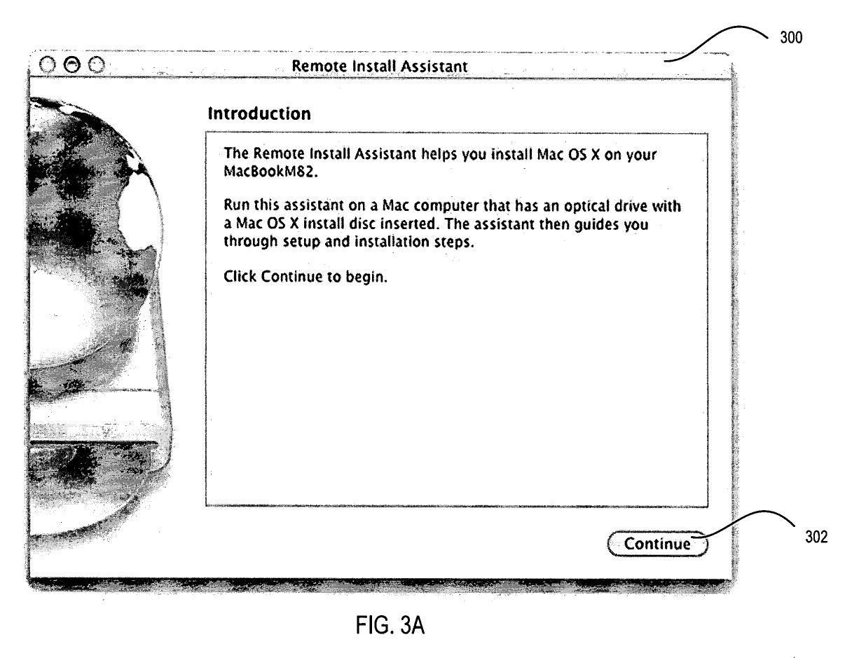

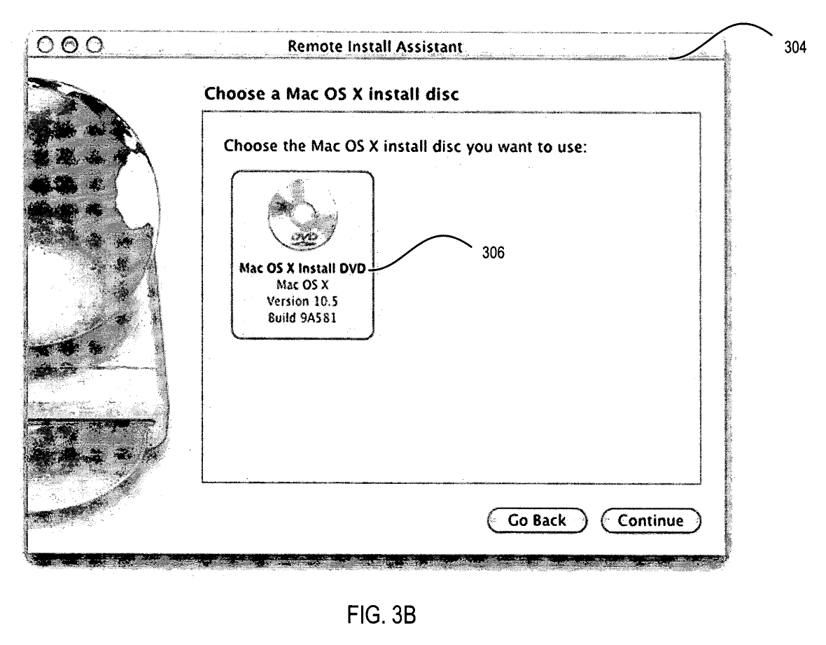

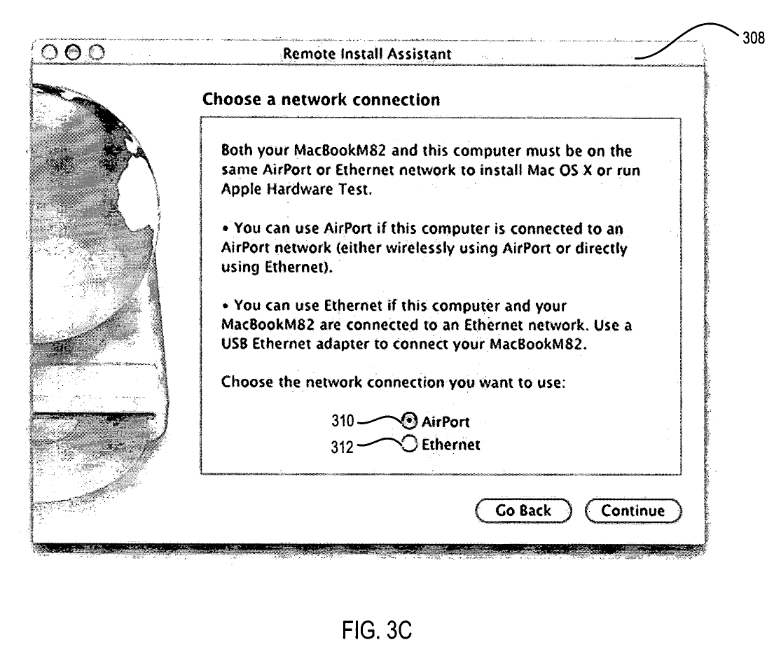

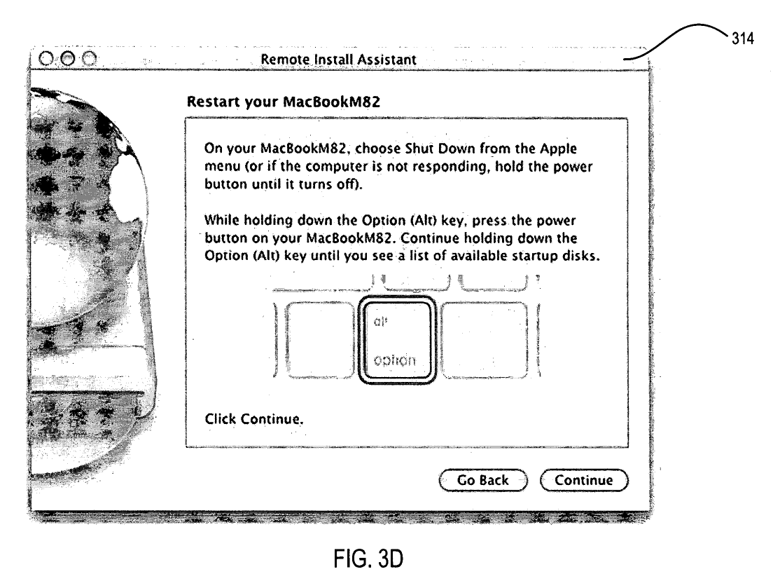

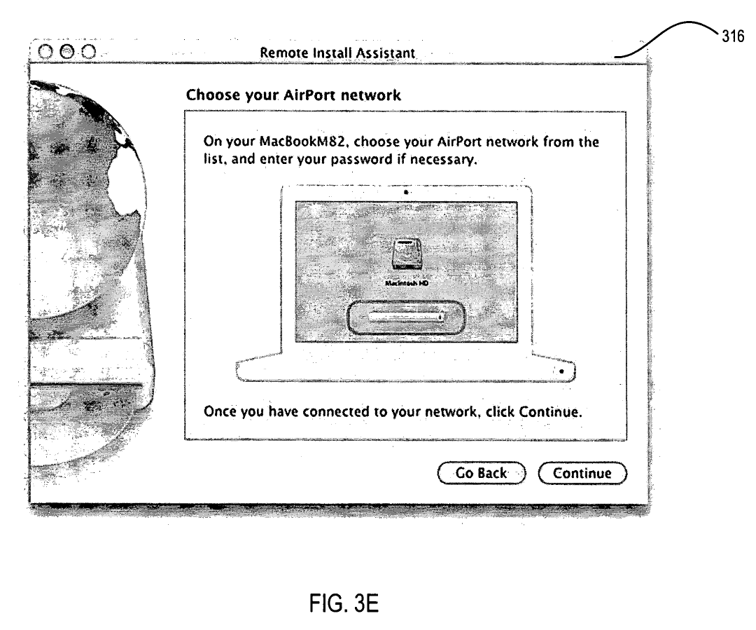

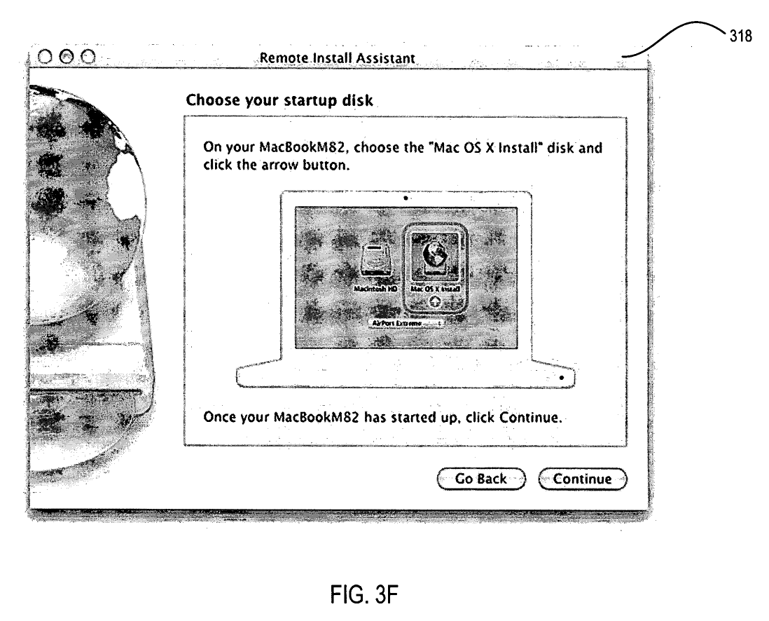

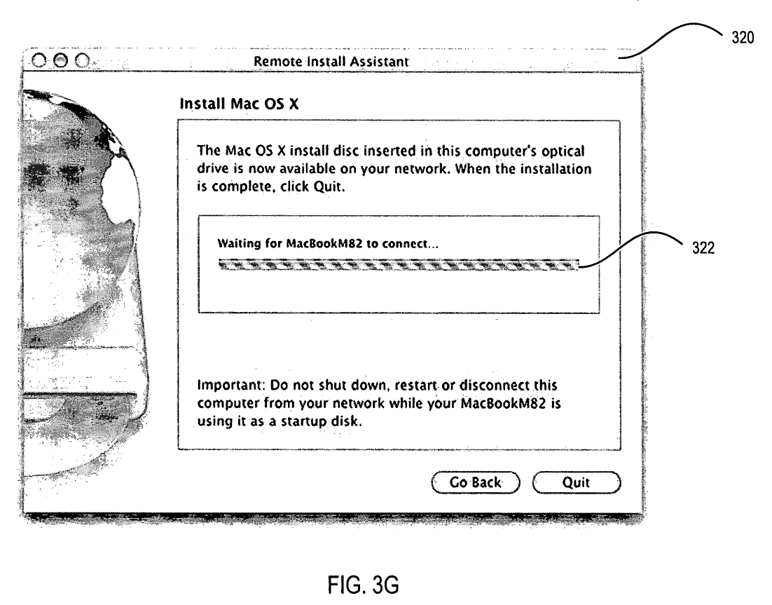

The user chooses a network startup disk on the host device from which to start the target device (208). The selection can be made by clicking on an icon or image of the startup disk presented on the target device. The contents of the optical disk is remotely installed (210) onto the target device using known disk installation technology (e.g., Mac OS® X Disk Utility restore). The progress of installation can be shown on the host device, as described in reference to FIG. 3G. In multiple disc installations, when a first disc has been installed the user is instructed to insert a second disk at the host device and continue with the installation process.

### Example Remote Install Assistant Process

FIGS. 3A-3G are screenshots of example instruction panes for an example remote install assistant. Other assistants are possible including more or fewer steps or instructions. Any kind of content can be used for providing instructions including but not limited to: images, video, animations, graphics, special effects, avatars, audio, etc.

FIG. 3A shows instruction pane 300 displayed on the host device which provides an introduction to the user on the remote install process. In the example shown, the user can click continue button 302 to receive the next instruction pane.

FIG. 3B shows instruction pane 304 displayed on the host device which allows the user to choose an optical disk for use in the remote install process. In the example shown, the user selects representation 306 (e.g., an icon) of a Mac OS® X install disk by clicking on representation 306 with their mouse or other pointing device. There can be more than one optical disk displayed on pane 304. When the user has selected a disc, the user can click continue button 302 to receive the next instruction pane.

FIG. 3C shows an instruction pane 308 displayed on the host device which allows the user to choose a network connection from a list of available networks. In the example shown, the user can select between wireless network 310 (e.g., AirPort®) or wired network 312 (e.g., Ethernet). The user can click continue button 302 to receive the next instruction pane.

FIG. 3D shows instruction pane 314 displayed on the host device for instructing the user on how to restart the target device. In the example shown, the user is instructed to shut down the target device (e.g., a MacBook® computer) by holding down the power button until the target device turns off. The user is then instructed to hold down the Option (Alt) key and press the power button, while continuing to hold down the Option (Alt) key, until the user sees a list of available startup disks displayed on the target device. The specific instructions provided will depend on the specific target device used. The user can click continue button 302 to receive the next instruction pane.

FIG. 3E shows instruction pane 316 displayed on the host device for instructing the user to choose a wireless network from a list of available networks displayed on the target device. In the example shown, pane 316 instructs the user to choose the AirPort® network from the list of available networks displayed on the target device, and optionally enter a password if the network is password protected. The user can click continue button 302 to receive the next instruction pane.

FIG. 3F shows instruction pane 318 displayed on the host device for instructing the user to choose a startup disc on the target device from one or more available discs. In the example shown, pane 318 instructs the user to choose the Mac OS® X install disk which was inserted in an optical drive of the host device and previously selected by the user in pane 304. The user can click continue button 302 to receive the next instruction pane.

FIG. 3G shows instruction pane 320 which confirms that the disc inserted in an optical disc drive of the host device is available on the network. Progress bar 322 or other user interface element can be displayed in pane 320 to provide feedback on the installation process and to request insertion of other discs in a multiple disc installation. The user can click the quit button shown in pane 320 to quit the remote install process.

### Example Host Device Architecture

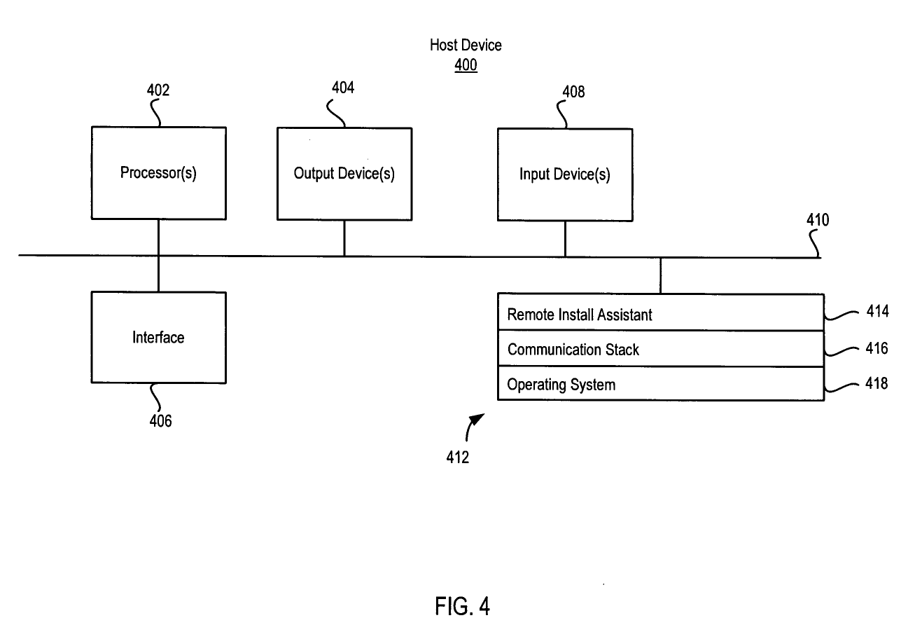

FIG. 4 is a block diagram of example host device 400 for implementing the features and processes described in reference to FIGS. 1-3. In some implementations, the host device 400 can include one or more processors 402 (e.g., dual-core Intel® Xeon® Processors), one or more output devices 404 (e.g., LCD), one or more network interfaces 406 (e.g., USB ports, wireless adaptor, FireWire® ports, Ethernet), one or more input devices 408 (e.g., mouse, keyboard, touch-sensitive display) and one or more computer-readable mediums 412 (e.g., RAM, ROM, SDRAM, hard disk, optical disk, flash memory, etc.). These components can exchange communications and data over one or more communication channels 410 (e.g., buses), which can utilize various hardware and software for facilitating the transfer of data and control signals between components.

The term “computer-readable medium” refers to any medium that participates in providing instructions to processor 402 for execution, including without limitation, non-volatile media (e.g., optical or magnetic disks), volatile media (e.g., memory) and transmission media. Transmission media can include, without limitation, coaxial cables, copper wire and fiber optics. Transmission media can also take the form of acoustic, light or radio frequency waves.

Computer-readable medium 412 can further include operating system 418 (e.g., Mac OS® server, Windows® NT server), communication stack 416 and remote install assistant 414. Operating system 418 can be multi-user, multiprocessing, multitasking, multithreading, real time, etc. Operating system 418 performs basic tasks, including but not limited to: recognizing input from and providing output to devices 408, 404; keeping track and managing files and directories on computer-readable mediums 412 (e.g., memory or a storage device); controlling peripheral devices; and managing traffic on one or more communication channels 410. Communication stack 416 can include various components for establishing and maintaining communication connections (e.g., software for implementing communication protocols, such as USB 2.0, FireWire®, Wi-Fi, Bluetooth, Ethernet, TCP/IP, HTTP, etc.). Remote install assistant 414 can perform process 200 described in reference to FIG. 2, and in some implementations, can be part of the communication stack 416. Remote install assistant 414 can use a graphics processing and windowing service (e.g., Mac OS® X Core Graphics service) to create and present the instruction panes described in reference to FIG. 3.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
providing one or more user interfaces on a host device;
obtaining input through the one or more user interfaces specifying a media, the media containing content and being integrated with or coupled to the host device;
obtaining input through the one or more user interfaces specifying a network;
presenting instructions in the one or more user interfaces for configuring a target device for remote installation of media content from the host device to the target device using the network; and
remotely installing media content from the host device onto the target device.

2. The method of claim 1, wherein the media content includes at least one component of an operating system.

3. The method of claim 1, wherein the network is a wireless network.

4. A computer-readable medium having instructions stored thereon, which, when executed by a processor, causes the processor to perform operations comprising:
providing one or more user interfaces on a host device;
obtaining input through the one or more user interfaces specifying a media the media containing content and being integrated with or coupled to the host device;
obtaining input through the one or more user interfaces specifying a network;
presenting instructions in the one or more user interfaces for configuring a target device for remote installation of media content from the host device to the target device using the network; and
remotely installing media content from the host device onto the target device.

5. The computer-readable medium of claim 4, wherein the content includes at least one component of an operating system.

6. The computer-readable medium of claim 4, wherein the network is a wireless network.

7. A system comprising:
a processor;
a computer-readable medium coupled to the processor and having instructions stored thereon, which, when executed by the processor, causes the processor to perform operations comprising:
providing one or more user interfaces on a host device;
obtaining input through the one or more user interfaces specifying a media, the media containing content and being integrated with or coupled to the host device;
obtaining input through the one or more user interfaces specifying a network;
presenting instructions in the one or more user interfaces for configuring a target device for remote installation of media content from the host device to the target device using the network; and
remotely installing media content from the host device onto the target device.

8. The system of claim 7, wherein the content includes at least one component of an operating system.

9. The system of claim 7, wherein the network is a wireless network.

10. A method comprising:
providing one or more user interfaces on a target device;
obtaining input through the one or more user interfaces specifying a media, the media containing content and being integrated with or coupled to a host device;
obtaining input through the one or more user interfaces specifying a network; and
remotely installing media content from the host device onto the target device.

11. The method of claim 10, wherein the content includes at least one component of an operating system.

12. The method of claim 10, wherein the network is a wireless network.

13. A computer-readable medium having instructions stored thereon, which, when executed by a processor, causes the processor to perform operations comprising:
providing one or more user interfaces on a target device;
obtaining input through the one or more user interfaces specifying a media, the media containing content and being integrated with or coupled to a host device;
obtaining input through the one or more user interfaces specifying a network; and
remotely installing media content from the host device onto the target device.

14. The computer-readable medium of claim 13, wherein the content includes at least one component of an operating system.

15. The computer-readable medium of claim 13, wherein the network is a wireless network.

16. A system comprising:
a processor;
a computer-readable medium coupled to the processor and having instructions stored thereon, which, when executed by the processor, causes the processor to perform operations comprising:
providing one or more user interfaces on a target device;
obtaining input through the one or more user interfaces specifying a media, the media containing content and being integrated with or coupled to a host device;
obtaining input through the one or more user interfaces specifying a network; and
remotely installing media content from the host device onto the target device.

17. The system of claim 16, wherein the content includes at least one component of an operating system.

18. The system of claim 16, wherein the network is a wireless network.

19. A system comprising:
a host device including a remote install assistant, the remote install assistance including a network installation server which makes a media device coupled to the host device available as a startup disk on a wireless network; and
a target device operable for communicating with the host device over the wireless network and for using the network integration server to perform a remote install of content on the media device from the host device onto the target device using the network.

20. The system of claim 19, wherein the content includes at least one component of an operating system.
